(19) United States
(12) Patent Application Publication
(10) Pub. No.: US 2011/0221607 A1
(43) Pub. Date: Sep. 15, 2011

(54) Dynamic Device Adaptation Based on Proximity to Other Devices

(75) Inventor: Rajesh Ramanathan, Redmond, WA (US)

(73) Assignee: MICROSOFT CORPORATION, Redmond, WA (US)

(21) Appl. No.: 12/724,176

(22) Filed: Mar. 15, 2010

(51) Int. Cl. G08B 21/00

(52) U.S. Cl. 340/686.6

(57) ABSTRACT

A communication device receives remote location data and uses the remote location data to determine whether an associated communication device is nearby. The associated communication device is nearby when the user is able to concurrently perceive actions performed by the communication device and the associated communication device. The communication performs a first action when the associated communication device is nearby and performs a second action when there are no communication devices associated with the user nearby.

### BACKGROUND

A single user can use multiple communication devices to participate in communication sessions. For example, a single user can use a desk telephone, a mobile telephone, and a desktop computer to participate in communication sessions. In some instances, when a single user uses multiple communication devices, each of the communication devices attempts to notify the user of an incoming session invitation. A session invitation is an invitation for a user to participate in a communication session. For example, when there is an incoming telephony call for the user, the user's desk telephone, the user's mobile telephone, and the user's desktop computer can all emit notification sounds to notify the user of the incoming telephony call. This can be advantageous when the user is close to only one of the user's communication devices. However, this can be annoying when the user is close to multiple ones of the user's communication devices. For example, when the user is in his or her office, the user could be simultaneously assailed by the notification sounds of each of the user's communication devices. In another example, when the user has multiple communication devices, the user might not know which of the communication devices would be best suited to participating in a communication session.

### SUMMARY

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

In one aspect, a method comprises receiving, by a communication device associated with a user, remote location data. The remote location data conveys information about a current location of an associated communication device. The method also comprises using, by the communication device, the remote location data to determine whether the associated communication device is nearby. The associated communication device is associated with the user. The associated communication device is nearby when the user is able to concurrently perceive actions performed by the communication device and the associated communication device. The method also comprises performing, by the communication device, a first action when the associated communication device is nearby. In addition, the method comprises performing, by the communication device, a second action when there are no communication devices associated with the user nearby. The second action is different than the first action.

In another aspect, a communication device comprises a processing system. The communication device also comprises a data storage system that stores software instructions that, when executed by the processing system, cause the communication device to send local location data to another computing device. The local location data conveys information about a current location of the communication device. The software instructions, when executed by the processing system, also cause the communication device to receive remote location data. The remote location data conveys information about a current location of an associated communication device. The software instructions, when executed by the processing system, also cause the communication device to use the remote location data to determine whether the associated communication device is nearby. The communication device is associated with a user and the associated communication device is associated with the user. The associated communication device is nearby when the user is able to concurrently perceive notification actions performed by the communication device and the associated communication device. In response to receiving a session invitation from the server system, the software instructions, when executed by the processing system, also cause the communication device to perform a first notification action when the associated communication device is nearby. In response to receiving a session invitation from the server system, the software instructions, when executed by the processing system, also cause the communication device to perform a second notification action when there are no communication devices associated with the user nearby. The session invitation is an invitation for the user to participate in a communication session.

In yet another aspect, a computer-readable data storage medium comprises software instructions that, when executed by a processing system of a communication device associated with a user, cause the communication device to use a speaker of the communication device to emit a sound. The software instructions, when executed by the processing system, also cause the communication device to generate local location data. The local location data conveys information about a current location of the communication device. The software instructions, when executed by the processing system, also cause the communication device to send the local location data to a server system. In response to receiving a session invitation from the server system, the software instructions, when executed by the processing system, also cause the communication device to use remote location data received from the server system to determine whether there is an associated communication device nearby. The associated communication device is associated with the user. The remote location data conveys information about a current location of the associated communication device. The associated communication device is nearby when the user is able to concurrently perceive notification actions performed by the communication device and the associated communication device. The communication device determines that the associated communication device is nearby when the remote location data indicates that the associated communication device is currently at a location where the associated communication device is able to detect the sound emitted by the communication device. When the associated communication device is nearby, the software instructions, when executed by the processing system, cause the communication device to use remote status data generated by the associated communication device to identify one or more appropriate notification actions. The remote status data comprises at least one of: user status data and device status data. The user status data conveys information about an availability of the user to use the associated communication device to participate in communication sessions. The device status data conveys information about capabilities and state of the associated communication device. In addition, when the associated communication device is nearby, the software instructions, when executed by the processing system, cause the communication device to perform the one or more appropriate notification actions. When no communication device associated with the user is nearby, the software instructions, when executed by the processing system, also cause the communication device to perform a default notification action. The session invitation is an invitation for the user to participate in a communication session.

### BRIEF DESCRIPTION OF THE DRAWINGS

FIG. 1 illustrates an example communication system.

FIG. 2 is a block diagram illustrating example logical components of a communication device.

FIG. 3A is a flowchart illustrating an example operation performed by a location module of the communication device to generate local location data.

FIG. 3B is a flowchart illustrating an example operation performed by the location module of the communication device to receive and store remote location data.

FIG. 4 is a flowchart illustrating an example operation performed by the communication device when the communication device receives a session invitation.

FIG. 5 is a flowchart illustrating an example operation performed by the communication device to identify and perform notification actions.

FIG. 6 is a block diagram illustrating an example computing device usable in the communication system.

### DETAILED DESCRIPTION

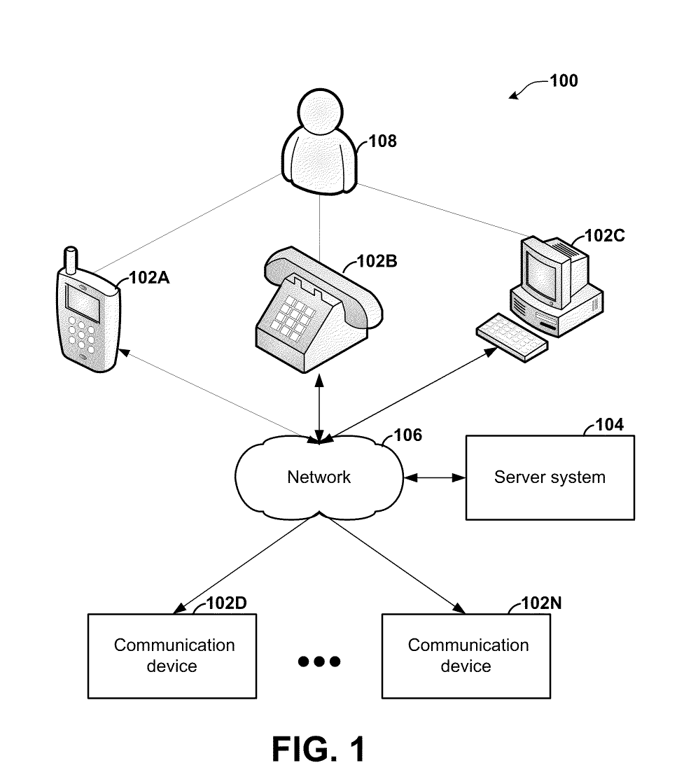

FIG. 1 illustrates an example communication system 100. The communication system 100 is a system for facilitating communication among users. The communication system 100 can be implemented in a variety of settings. For example, the communication system 100 can be implemented in the context of a single enterprise. In another example, the communication system 100 can be implemented by several enterprises.

As illustrated in the example of FIG. 1, the communication system 100 includes communication devices 102A-102N (collectively, “communication devices 102”), a server system 104, and a network 106. It should be appreciated that in other embodiments, the communication system 100 includes more or fewer components.

Each of the communication devices 102 is a physical, tangible device that enables a user to participate in a communication session. As used herein, a communication session is a two or more way interchange of information between a human user and one or more human or non-human other entities, the interchange perceived by the human user to be occurring in real time.

The communication devices 102 can be various types of communication devices. For example, the communication devices 102 can be landline telephones, mobile telephones, pagers, desktop computers, laptop computers, television set top boxes, video game consoles, handheld computers, smartphones, slate computers, tablet computers, booklet computers, netbook computers, devices integrated into vehicles, and so on. In the example of FIG. 1, the communication device 102A is a mobile telephone, the communication device 102B is a landline telephone, and the communication device 102C is a desktop computer configured to act as a communication device. It should be appreciated that FIG. 1 is an example and that the communication system 100 does not need to include a mobile telephone, a landline telephone, and a desktop computer.

The server system 104 enables users to establish communication sessions with other users. The server system 104 comprises one or more computing devices. As used herein, a computing device is a physical, tangible device that processes information. In various embodiments, the server system 104 comprises various types of computing devices. For example, the server system 104 can comprise one or more standalone server devices, blade server devices, personal computers, mainframe computers, supercomputers, and/or other types of computing devices. A communication device is a particular type of computing device.

In various embodiments, the server system 104 enables users to establish communication sessions having various types of content streams. As used herein, a content stream is a stream of data representing a conceptually independent interchange of information. Furthermore, as used herein, content data is data in a content stream. Example types of content streams include voice telephony streams, video conferencing streams, network meetings, instant messaging sessions, chat rooms, application sharing streams, and so on. Furthermore, in some embodiments, the server system 104 enables users to establish communication sessions having multiple content streams. For example, the server system 104 can enable users to establish communication sessions having a voice telephony stream and an instant messaging session.

The network 106 is a collection of computing devices and links that facilitate communication among the communication devices 102 and the server system 104. In various embodiments, the network 106 includes various types of computing devices. For example, the network 106 can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices. In various embodiments, the network 106 includes various types of links. For example, the network 106 can include wired and/or wireless links. Furthermore, in various embodiments, the network 106 is implemented at various scales. For example, the network 106 can be implemented as one or more local area networks (LANs), metropolitan area networks, subnets, wide area networks (such as the Internet), or can be implemented at another scale.

Each of the communication devices 102 is associated with a user. As used herein, a communication device is associated with a user when the communication device is registered with the server system 104 to receive session invitations for the user to participate in communication sessions. Multiple ones of the communication devices 102 can be associated with the same user. In the example of FIG. 1, the communication devices 102A, 102B, and 102C are associated with a user 108. As used herein, two or more communication devices are associated communication devices when the communication devices are associated with the same user. In the example of FIG. 1, the communication devices 102A, 102B, and 102C are associated communication devices. When two or more of communication devices are associated with the same user, the two or more communication devices can act as multiple points of presence for the user.

Each of the communication devices 102 generates location data. The location data generated by the communication devices 102 provides information about the current locations of the communication devices 102. The location data generated by the communication devices 102 can specify one or more types of information about the current locations of the communication devices 102. For example, the location data generated by a communication device can indicate the communication device is located at specific geographical coordinates. In some instances, the communication device can obtain such geographical coordinates using a global positioning system (GPS). In another example, the location data generated by a communication device can indicate that the communication device is at a location that is within range of a sound emitted by another communication device. In yet another example, the location data generated by a communication device can indicate that the communication device is at a location that is within range of a radio frequency signal (e.g., Bluetooth, WiFi, etc.) emitted by another communication device. In yet another example, the location data generated by a communication device can indicate that the communication device is at a location that is within range of an infrared signal emitted by another communication device. In yet another example, the location data generated by a communication device can identify a subnet of the communication device. The subnet of the communication device provides information about a location of the communication device because communication devices in the same subnet are at locations serviced by the subnet. In yet another example, the location data generated by a communication device can indicate a Media Access Control (MAC) address or serial number of a network access point through which the communication device is connected to the network 106. The MAC address or serial number of the network access point provides information about a location of the communication device because communication devices that connect to the network 106 through the same network access point are at locations serviced by the network access point. In addition to the types of information discussed in the preceding examples, the location data generated by a communication device can include other types of information about a location of the communication device.

Each of the communication devices 102 receives location data generated by other ones of the communication devices 102. In various embodiments, the communication devices 102 receive location data generated by other ones of the communication devices 102 in various ways. For example, in some embodiments, the communication devices 102 receive location data sent by other ones of the communication devices 102 in a peer-to-peer manner. In another example, each of the communication devices 102 sends location data to the server system 104. The server system 104 then redistributes the location data to the communication devices 102. In this example, the server system 104 can use a presence data system to receive and distribute the location data.

In various embodiments, the communication devices 102 receive location data generated by various other ones of the communication devices 102. For example, in some embodiments, each of the communication devices 102 receives location data from each of the other ones of the communication devices 102. In another example, the communication devices 102 only receive location data from other ones of the communication devices 102 that are associated with the same user. For instance, the communication device 102A receives location data from the communication device 102B and the communication device 102C, but not the communication devices 102D-102N.

When a first user wants a second user to participate in a communication session, session invitations are sent to each communication device associated with the second user. In various embodiments, session invitations are sent to each communication device associated with the second user in various ways. For example, in some embodiments, a communication device associated with the first user sends a participation request to the server system 104. In response to receiving the participation request, the server system 104 sends a session invitation to each communication device associated with the second user. In other embodiments, a communication device associated with the first user sends session invitations to each communication device associated with the second user in a peer-to-peer fashion.

The session invitations are invitations for the second user to participate in the communication session. For example, when a user wants the user 108 to participate in a communication session, the server system 104 sends session invitations to the communication device 102A, the communication device 102B, and the communication device 102C.

When the communication devices 102 receive session invitations, the communication devices automatically use remote location data, and in some instances local location data, to determine whether there are any associated communication devices nearby. The remote location data is location data generated by other communication devices. The local location data is location data generated by the communication device. As used herein, a first communication device is nearby relative to a second communication device when a user is likely able to concurrently perceive notification actions generated by the first communication device and the second communication device. In the example of FIG. 1, the communication device 102A can use the location data to determine whether the communication device 102B and the communication device 102C are nearby. Likewise, the communication device 102B and the communication device 102C use the location data in a similar way with respect to each other and with respect to the communication device 102A.

When one of the communication devices 102 determines that there are one or more associated communication devices nearby, the communication device identifies one or more appropriate actions to perform. In some instances, the appropriate actions are notification actions. A notification action is an action that notifies a user of something. Example types of notification actions include emitting notification sounds (e.g., a ringtone, beep, etc.), displaying an element on a graphical user interface (e.g., a toast, graphic, icon, window, etc.), vibrating, and other actions that notify a user that a session invitation has been received. A toast is a user interface element that notifies a user of an incoming session invitation. Other types of notification actions notify the user regarding other types of information, such as the presence of other devices or the capabilities of other devices. After identifying the one or more appropriate actions to perform, the communication device performs the one or more identified appropriate actions. As discussed elsewhere in this document, the communication devices 102 can also determine whether there are associated communication devices nearby and identify appropriate actions in situations other than in response to receiving session invitations.

In some embodiments, each of the communication devices 102 receives status data generated by other ones of the communication devices 102. In such embodiments, the communication devices 102 use the status data to identify appropriate actions to perform. In various embodiments, the communication devices 102 receive status data generated by other ones of the communication devices 102 in various ways. For example, in some embodiments, the communication devices 102 receive status data generated by other ones of the communication devices 102 in a peer to peer manner. In other embodiments, the communication devices 102 provide status data to the server system 104. In such embodiments, the server system 104 then redistributes the status data to the communication devices 102.

In various embodiments, the communication devices 102 receive status data generated by various other ones of the communication devices 102. For example, in some embodiments, each of the communication devices 102 receives status data from each of the other ones of the communication devices 102. In another example, the communication devices 102 only receive status data from other ones of the communication devices 102 that are associated with the same user. For instance, the communication device 102A receives status data from the communication device 102B and the communication device 102C, but not the communication devices 102D-102N.

The status data can convey a wide variety of different types of information. For example, the status data generated by one of the communication devices 102 can include user status data. The user status data generated by a communication device conveys information about an availability and willingness of a user associated with the communication device to communicate using the communication device. In various embodiments, the communication devices 102 can use user status data to identify appropriate actions in various ways. For example, a first and a second communication device are associated with a user. In this example, the user status data generated by the first communication device indicates whether the user is using the first communication device to participate in a communication session. The second communication device determines that emitting a notification sound is not an appropriate action when the first communication device is nearby and the user status data generated by the first communication device indicates that the user is using the first communication device to participate in a communication session.

Furthermore, in the some embodiments, the status data can include device status data. The device status data generated by a communication device conveys information about the capabilities and the state of the communication device. In various embodiments, the communication devices 102 can use device status data to identify appropriate actions in various ways. For example, a first and a second communication device are associated with a user. In this example, the first communication device generates device status data that indicates a resource utilization level of the first communication device. The second communication device identifies a notification sound as an appropriate action when the first communication device is nearby and the device status data generated by the first communication device indicates that the resource utilization level of the first communication device exceeds a given limit Consequently, when the first communication device is too busy to handle the communication session in a satisfactory way, the user will likely use the second communication device to participate in the communication session instead of the first communication device.

In another example, a first and a second communication device are associated with a user. The first communication device generates device status data that indicates whether the first communication device is currently displaying a presentation in full screen mode. It may not be desirable for a toast to appear on the display screen of the first communication device when a presentation is displayed in full screen mode. In this example, the first communication device does not display a toast. However, the second communication device identifies an alarm sound and a toast as appropriate actions when the first communication device is nearby and the device status data generated by the first communication device indicates that the first communication device is displaying a presentation in full screen mode.

In yet another example, a first and a second communication device are associated with a user. The device status data generated by the first communication device indicates a time when the user last provided input to the first communication device. The second communication device identifies an alarm sound as an appropriate action when the first communication device is nearby and the device status data indicates that the user has provided input to the second communication device more recently than to the first communication device.

In yet another example, a first and a second communication device are associated with a user. The device status data generated by the first communication device indicates that the first communication device is able to provide a particular feature at a given level. For instance, the device status data generated by the first communication device can indicate that the first communication device is able to provide video at a high resolution. When the second communication device determines that the second communication device is not able to provide the particular feature at the given level, the second communication device identifies an action that comprises displaying a user interface element that indicates that a nearby communication device is able to provide the particular feature at a higher level than the second communication device.

When one of the communication devices 102 determines that there are no associated communication devices nearby, the communication device performs a default action. The default action can be different than an action performed when there are one or more associated communication devices nearby. Thus, the communication device can perform different actions depending on whether associated communication devices are nearby. In other words, a communication device performs a first action when an associated communication device is nearby and performs a second action when no other associated communication device is nearby.

For example, when the communication device 102A receives a session invitation, the communication device 102A can emit a notification sound and display a toast when neither the communication device 102B nor the communication device 102C is nearby. In this example, the communication device 102A can display the toast, but not emit the notification sound, when either the communication device 102B or the communication device 102C is nearby. In this example, either the communication device 102B or the communication device 102C can emit the notification sound. In this way, the user 108 is not bombarded with notification sounds from the communication device 102A, the communication device 102B, and the communication device 102C when these communication devices receive session invitations. In another example, when the communication device 102A receives a session invitation, the communication device 102A can emit a notification sound at one volume when neither the communication device 102B nor the communication device 102C is nearby. In this other example, the communication device 102A emits a notification sound at another volume when either the communication device 102B or the communication device 102C is nearby.

When the user perceives a notification action performed by any communication device associated with the user, the user can use any of the communication devices associated with the user to accept or decline the session invitation. For instance, the user 108 can use the communication device 102A, the communication device 102B, or the communication device 102C to accept or decline session invitations to participate in a communication session. When the user accepts the session invitation, the user can begin participating in the communication session.

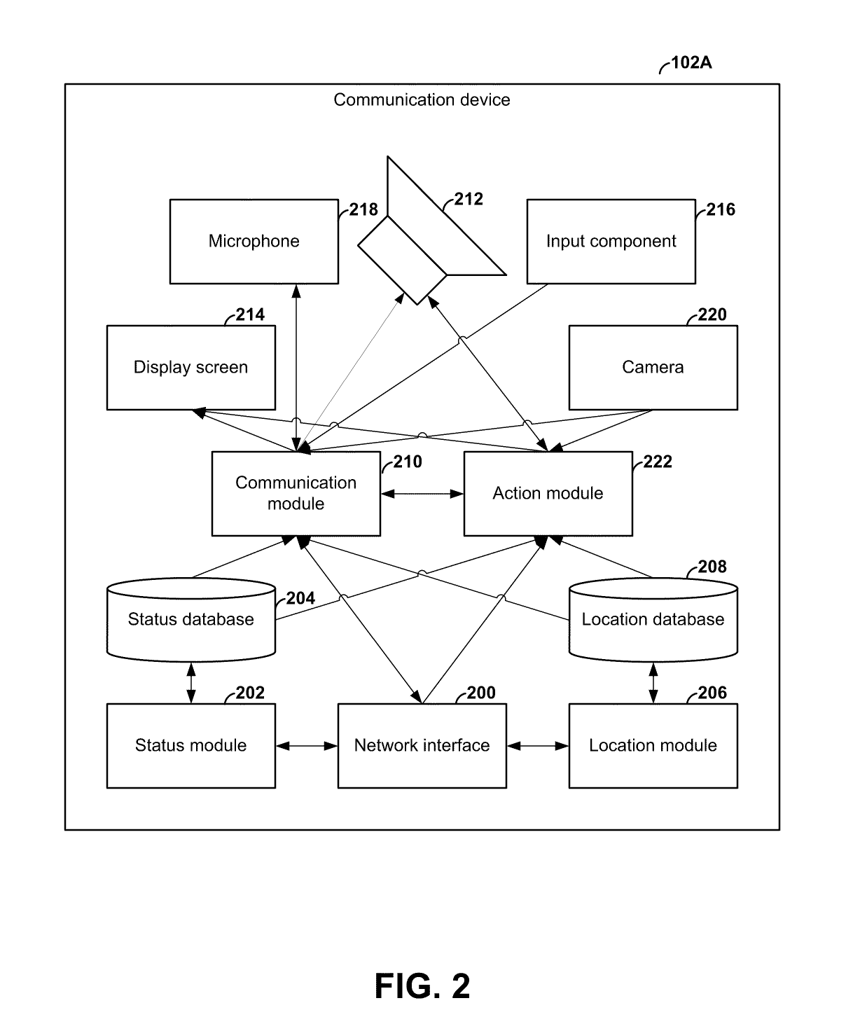

FIG. 2 is a block diagram showing example logical components of the communication device 102A. As illustrated in the example of FIG. 2, the communication device 102A includes a network interface 200, a status module 202, a status database 204, a location module 206, a location database 208, a communication module 210, a speaker 212, a display screen 214, an input component 216, a microphone 218, a camera 220, and an action module 222. It should be appreciated that each of the communication devices 102 can include the logical components illustrated in the example of FIG. 2.

In various embodiments, the status module 202, the location module 206, the communication module 210, and the action module 222 are implemented in various ways. For example, in some embodiments, the communication device 102A provides the status module 202, the location module 204, the communication module 210, and the action module 222 when one or more processing systems in the communication device 102A execute software instructions stored on one or more computer-readable data storage media.

Furthermore, in various embodiments, the status database 204 and the location database 208 are implemented in various ways. For example, in some embodiments, the status database 204 and/or the location database 208 can be implemented as relational databases. In other embodiments, the status database 204 and/or the location database 208 can be implemented as flat files, lookup tables, directories, or other data structures. In some embodiments, the status database 204 and the location database 208 are parts of the same logical data structure. For instance, in some embodiments, the status database 204 and the location database 208 can be implemented in the same relational database.

The network interface 200 enables the communication device 102A to send and receive data on the network 106. In various embodiments, the network interface 200 can be implemented by various types of hardware components. For example, the network interface 200 can be an Ethernet card, a wireless networking card, a modem, or another type of hardware component that enables sending and receiving data on a network.

The status module 202 receives status data from the network interface 200 and stores the received status data in the status database 204. Furthermore, the status module 202 generates status data regarding the communication device 102A. The status module 202 uses the network interface 200 to provide status data generated by the status module 202 to other communication devices.

The location module 206 receives location data from the network interface 200 and stores the received location data in the location database 208. Furthermore, the location module 206 generates location data regarding the communication device 102A. The location module 206 uses the network interface 200 to provide location data generated by the location module 206 to other communication devices.

The communication module 210 receives session invitations from the network interface 200. When the communication module 210 receives a session invitation, the action module 222 uses location data in the location database 208 to determine whether there are any communication devices associated with the user 108 nearby. If there are no communication devices associated with the user 108 nearby, the action module 222 performs a default action. If there are one or more communication devices associated with the user 108 nearby, the action module 222 uses status data in the status database 204 to identify one or more appropriate actions. The action module 222 can use the speaker 212 and/or the display screen 214 to perform actions.

If the user 108 decides to accept the session invitation, the input component 216 receives invitation acceptance input from the user 108. The invitation acceptance input indicates that the user 108 wants to accept the session invitation. The input component 216 provides the invitation acceptance input to the communication module 210. When the communication module 210 receives the invitation acceptance input, the communication module 210 uses the network interface 200 to begin participating in the communication session. After the communication device 102A begins participating in the communication session, the communication module 210 processes content data to output one or more content streams using the display screen 214 and/or the speaker 212. Furthermore, the communication module 210 receives content data from the input component 216, the microphone 218, and/or the camera 220, processes this content data, and uses the network interface 200 to send the processed content data to other communication devices participating in the communication session.

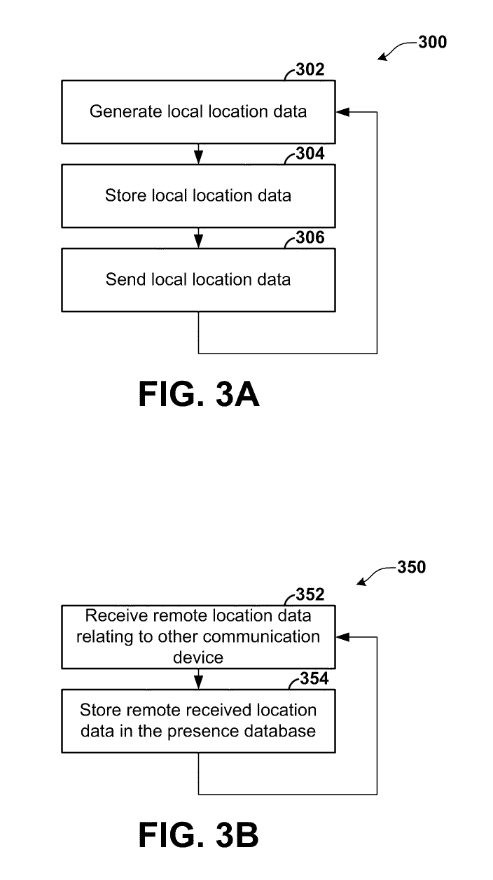

FIG. 3A is a flowchart illustrating an example operation 300 performed by the location module 206 of the communication device 102A to generate location data. Although the operation 300 is explained as being performed by the location module 206 of the communication device 102A, other logical components of other ones of the communication devices 102 can perform the operation 300.

As illustrated in the example of FIG. 3A, the operation 300 begins when the location module 206 generates location data (302). In various embodiments, the location module 206 performs various actions to generate the location data. For example, the communication device 102B emits a sound. In this example, when the microphone 218 detects the sound, the location module 206 generates location data that indicates that the communication device 102A is at a location within range of the sound. In another example, the communication device 102C emits a radio frequency (RF) signal, such as a Bluetooth signal. In this example, when the network interface 200 detects the RF signal, the location module 206 generates location data that indicates that the communication device 102A is at a location within range of the RF signal. In yet another example, the location module 206 uses the network interface 200 to obtain a MAC address of a network access point through which the communication device 102A is connected to the network 106. In this example, the status module 202 can use the Link Layer Discovery Protocol (LLDP) or Media Endpoint Discovery (MED) protocol to obtain the MAC address of the network access point. The location module 206 generates location data comprising an attribute specifying the MAC address of the network access point. Based on the MAC address of the network access point, the communication device 102B and the communication device 102C are able to determine whether the communication device 102A is at a location where the communication device 102A can connect to the network 106 through the network access point.

After generating the location data, the status module 202 stores the location data in the location database 208 (304). The location module 206 then uses the network interface 200 to provide the location data to other communication devices (306). The location module 206 can subsequently generate and send additional location data. For example, the location module 206 can generate and send additional location data in accordance with a regular schedule, in response to user input, in response to a change to an attribute of the location data, or in response to other events.

FIG. 3B is a flowchart illustrating an example operation 350 performed by the location module 206 of the communication device 102A to receive and store remote location data. Although the operation 350 is explained as being performed by the location module 206 of the communication device 102A, other logical components of other ones of the communication devices 102 can perform the operation 350.

As illustrated in the example of FIG. 3B, the operation 350 begins when the location module 206 receives remote location data (352). The remote location data was generated by another communication device. After receiving the remote location data, the location module 206 stores the remote location data in the location database 208 (308). The location module 206 repeats the operation 350 each time the location module 206 receives remote location data.

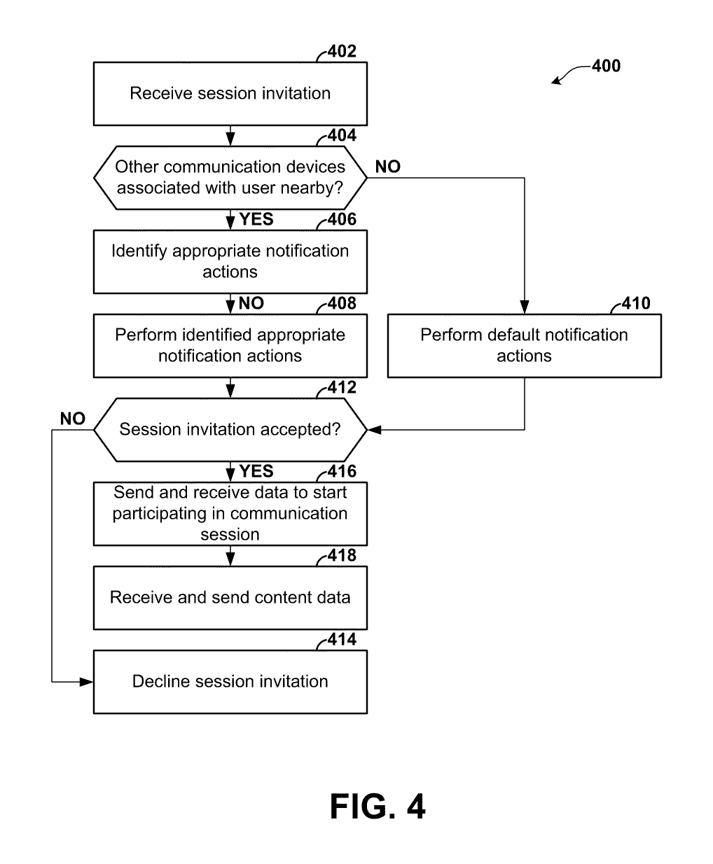

FIG. 4 is a flowchart illustrating an example operation 400 performed by the communication device 102A when the communication device 102A receives a session invitation. Although the operation 400 is explained as being performed by the communication device 102A, other ones of the communication devices 102 can perform the operation 400.

As illustrated in the example of FIG. 4, the operation 400 begins when the communication module 210 of the communication device 102A receives a session invitation from the server system 104 (402). The session invitation is an invitation for the user 108 to participate in a communication session.

Upon receiving the session invitation, the action module 222 uses remote location data and local location data in the location database 208 to determine whether there are any communication devices associated with the user 108 nearby (404). If there are one or more communication devices associated with the user 108 nearby (“YES” of 404), the action module 222 uses remote status data and local status data in the status database 204 to identify one or more appropriate actions to perform (406).

In various embodiments, the action module 222 can identify the one or more appropriate actions in various ways. For example, in some embodiments, in some embodiments, each of the communication devices 102 stores a set of rules. Each of the rules maps a condition to one or more appropriate actions. The condition is based on values specified in the remote status data or the local status data.

In this example, the communication devices 102 process the rules to identify the one or more appropriate actions. In various embodiments, the communication devices 102 use various rules engines to process the rules. For example, the communication devices 102 can use a forward chaining rules engine, such as the Rete algorithm, to process the rules. Because each of the communication devices 102 stores the same set of rules, each of the communication devices 102 can independently identify appropriate actions in a consistent way.

In this example, the set of rules can include a wide variety of rules. For instance, one of the rules can specify that emitting a notification sound is an appropriate action when the remote status data indicates that the user 108 has provided input to the communication device 102A more recently than to each of the nearby communication devices associated with the user 108. In another instance, one of the rules specifies that emitting a notification sound and displaying a toast are appropriate actions when the remote status data indicates that one or more of the nearby communication devices associated with the user 108 does not have an ability to present a content stream of the communication session, but the communication device 102A has the ability to present the content stream of the communication session. In yet another example, a rule can specify that emitting a notification sound is an appropriate action when none of the nearby communication devices associated with the user 108 has sufficient processing resources to handle the communication session. In yet another instance, a rule can specify that vibrating is an appropriate action when a display screen of one of the nearby communication devices associated with the user 108 is locked and the display screen 214 is not locked.

The action module 222 then performs the one or more identified appropriate actions (408). The one or more actions are notification actions that notify the user 108 of the session invitation. For example, the action module 222 can cause the display screen 214 to display a notification message. If there are no other communication devices associated with the user 108 nearby (“NO” of 404), the action module 222 performs one or more default actions (410). The one or more default actions are notification actions to notify the user 108 of the session invitation. For example, the action module 222 can cause the speaker 212 to emit a notification sound and cause the display screen 214 to display a notification message.

After the action module 222 performs either the one or more identified appropriate actions or the one or more default actions, the communication module 210 determines whether the user 108 accepted the session invitation (412). If the user 108 did not accept the session invitation (“NO” of 412), the communication module 210 uses the network interface 200 to send a message indicating that the user 108 declined the session invitation (414).

On the other hand, if the user 108 accepted the session invitation (“YES” of 412), the communication module 210 uses the network interface 200 to send and receive data to start participating in the communication session (416). Thereafter, the communication module 210 receives and sends content data related to the communication session (418). For example, the communication module 210 can receive and send content data representing a video stream in the communication session.

In some embodiments, the action module 222 performs additional actions when the user 108 accepts the session invitation. For example, in some embodiments, when the user 108 accepts the session invitation, the action module 222 uses the status data in the status database 204 to determine whether another one of the nearby associated communication devices is able to provide the communication session at a higher level of quality. In this example, the action module 222 can perform one or more actions to notify the user 108 that one or more of the nearby associated communication devices is able to provide the communication session at a higher level of quality. For example, the action module 222 can use the display screen 214 to display a toast that notifies the user 108 that one or more of the nearby associated communication devices is able to provide the communication session at a higher level of quality.

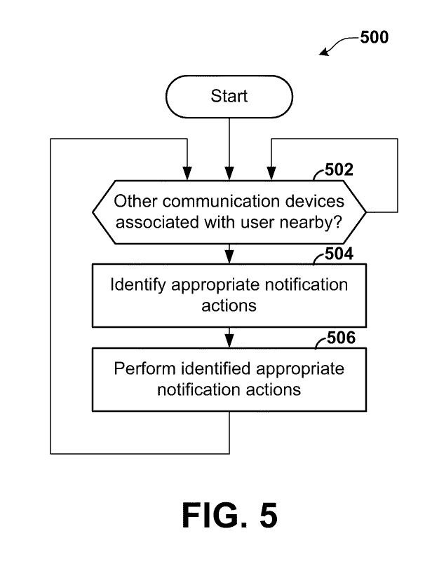

FIG. 5 is a flowchart illustrating an example operation 500 performed by the communication device 102A to identify and perform actions. Although the operation 500 is explained as being performed by the communication device 102A, other ones of the communication devices 102 can perform the operation 500.

As illustrated in the example of FIG. 5, the operation 500 begins when the action module 222 determines whether there are one or more associated communication devices nearby (502). In some embodiments, the action module 222 determines whether there are one or more associated communication devices nearby in the same way that the action module 222 determines whether there are associated communication devices nearby in step 404 of FIG. 4. However, in the operation 500, the action module 222 does not necessarily make this determination in response to the communication device 102A receiving a session invitation. Rather, the action module 222 can determine whether there are associated communication devices nearby in various other situations. For example, in some embodiments, the action module 222 determines whether there are associated communication devices nearby in a periodic basis. Furthermore, in some embodiments, the action module 222 determines whether there are associated communication devices nearby in response to one or more events. For instance, the action module 222 can determine whether there are associated communication devices nearby when the user 108 accepts a session invitation, when the communication device 102A detects a signal from another device, when the communication device 102A receives input from a user, and so on. Consequently, the action module 222 can determine whether there are associated communication devices nearby before or after the user 108 begins participating in a communication session.

If the action module 222 determines that there are no associated communication devices nearby (“NO” of 502), the action module 222 waits and then subsequently determines again whether there are one or more associated communication devices nearby (502). On the other hand, in response to determining that there are one or more associated communication devices nearby (“YES” of 502), the action module 222 identifies one or more appropriate actions (504). In some embodiments, the action module 222 identifies the appropriate actions in the same way that the action module 222 identifies appropriate actions in step 406 of FIG. 4.

After identifying the appropriate actions, the action module 222 performs the appropriate actions (506). In various embodiments, the action module 222 performs various actions. For example, while the user 108 is using the communication device 102A to participate in a communication session, the action module 222 determines that another associated communication device with greater abilities is nearby. For instance, the other associated communication device might have a high definition webcam as opposed to a standard definition webcam. In this example, the action module 222 performs an action to notify the user 108 that the other associated communication device has greater abilities. The action module 222 can perform this action while the user 108 is using the communication device 102A to participate in the communication session. After the action module 222 performs the appropriate actions, the action module 222 loops back and subsequently determines again whether there are any associated communication devices nearby (502).

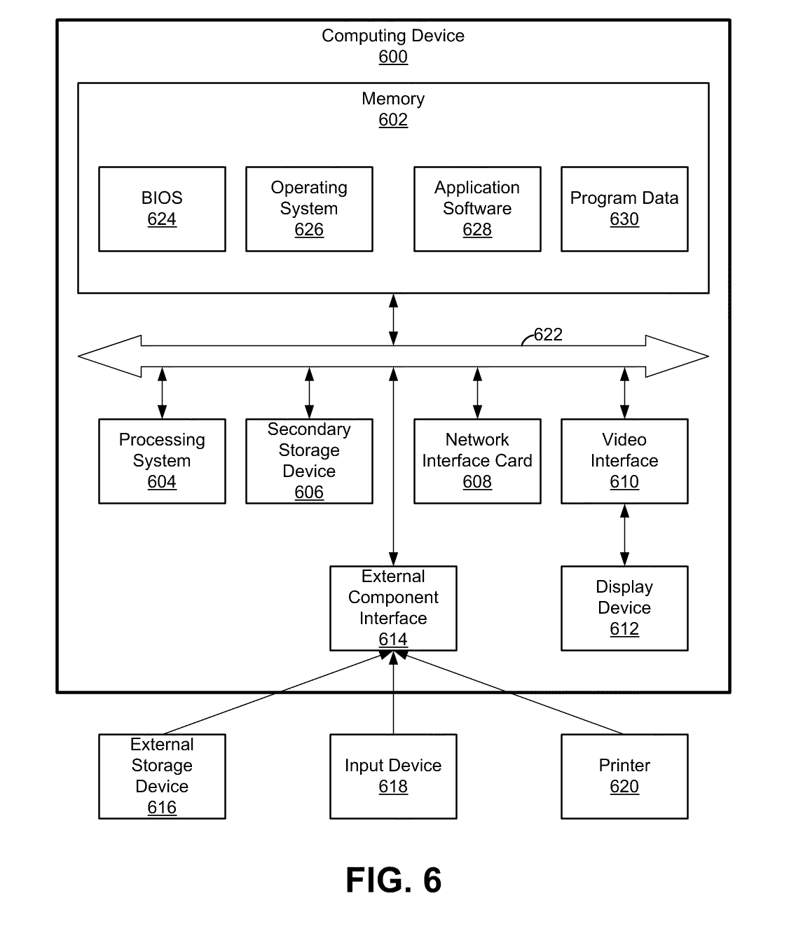

FIG. 6 is a block diagram illustrating an example computing device 600 usable in the communication system 100. In some embodiments, the communication devices 102 and/or the server system 104 are implemented using one or more computing devices like the computing device 600. It should be appreciated that in other embodiments, the communication devices 102 and/or the server system 104 are implemented using computing devices having hardware components other than those illustrated in the example of FIG. 6.

In different embodiments, computing devices are implemented in different ways. For instance, in the example of FIG. 6, the computing device 600 comprises a memory 602, a processing system 604, a secondary storage device 606, a network interface card 608, a video interface 610, a display device 612, an external component interface 614, an external storage device 616, an input device 618, a printer 620, and a communication medium 622. In other embodiments, computing devices are implemented using more or fewer hardware components. For instance, in another example embodiment, a computing device does not include a video interface, a display device, an external storage device, or an input device.

The memory 602 includes one or more computer-readable data storage media capable of storing data and/or instructions. As used in this document, a computer-readable data storage medium is a device or article of manufacture that stores data and/or software instructions readable by a computing device. In different embodiments, the memory 602 is implemented in different ways. For instance, in various embodiments, the memory 602 is implemented using various types of computer-readable data storage media. Example types of computer-readable data storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The processing system 604 includes one or more physical integrated circuits that selectively execute software instructions. In various embodiments, the processing system 604 is implemented in various ways. For instance, in one example embodiment, the processing system 604 is implemented as one or more processing cores. For instance, in this example embodiment, the processing system 604 may be implemented as one or more Intel Core 2 microprocessors. In another example embodiment, the processing system 604 is implemented as one or more separate microprocessors. In yet another example embodiment, the processing system 604 is implemented as an ASIC that provides specific functionality. In yet another example embodiment, the processing system 604 provides specific functionality by using an ASIC and by executing software instructions.

In different embodiments, the processing system 604 executes software instructions in different instruction sets. For instance, in various embodiments, the processing system 604 executes software instructions in instruction sets such as the x86 instruction set, the POWER instruction set, a RISC instruction set, the SPARC instruction set, the IA-64 instruction set, the MIPS instruction set, and/or other instruction sets.

The secondary storage device 606 includes one or more computer-readable data storage media. The secondary storage device 606 stores data and software instructions not directly accessible by the processing system 604. In other words, the processing system 604 performs an I/O operation to retrieve data and/or software instructions from the secondary storage device 606. In various embodiments, the secondary storage device 606 is implemented by various types of computer-readable data storage media. For instance, the secondary storage device 606 may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card 608 enables the computing device 600 to send data to and receive data from a computer communication network. In different embodiments, the network interface card 608 is implemented in different ways. For example, in various embodiments, the network interface card 608 is implemented as an Ethernet interface, a token-ring network interface, a fiber optic network interface, a wireless network interface (e.g., WiFi, WiMax, etc.), or another type of network interface.

The video interface 610 enables the computing device 600 to output video information to the display device 612. In different embodiments, the video interface 610 is implemented in different ways. For instance, in one example embodiment, the video interface 610 is integrated into a motherboard of the computing device 600. In another example embodiment, the video interface 610 is a video expansion card. Example types of video expansion cards include Radeon graphics cards manufactured by ATI Technologies, Inc. of Markham, Ontario, Geforce graphics cards manufactured by Nvidia Corporation of Santa Clara, Calif., and other types of graphics cards.

In various embodiments, the display device 612 is implemented as various types of display devices. Example types of display devices include, but are not limited to, cathode-ray tube displays, LCD display panels, plasma screen display panels, touch-sensitive display panels, LED screens, projectors, and other types of display devices. In various embodiments, the video interface 610 communicates with the display device 612 in various ways. For instance, in various embodiments, the video interface 610 communicates with the display device 612 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 614 enables the computing device 600 to communicate with external devices. In various embodiments, the external component interface 614 is implemented in different ways. For instance, in one example embodiment, the external component interface 614 is a USB interface. In other example embodiments, the computing device 600 is a FireWire interface, a serial port interface, a parallel port interface, a PS/2 interface, and/or another type of interface that enables the computing device 600 to communicate with external components.

In different embodiments, the external component interface 614 enables the computing device 600 to communicate with different external components. For instance, in the example of FIG. 6, the external component interface 614 enables the computing device 600 to communicate with the external storage device 616, the input device 618, and the printer 620. In other embodiments, the external component interface 614 enables the computing device 600 to communicate with more or fewer external components. Other example types of external components include, but are not limited to, speakers, phone charging jacks, modems, media player docks, other computing devices, scanners, digital cameras, a fingerprint reader, and other devices that can be connected to the computing device 600.

The external storage device 616 is an external component comprising one or more computer readable data storage media. Different implementations of the computing device 600 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. The input device 618 is an external component that provides user input to the computing device 600. Different implementations of the computing device 600 interface with different types of input devices. Example types of input devices include, but are not limited to, keyboards, mice, trackballs, stylus input devices, key pads, microphones, joysticks, touch-sensitive display screens, and other types of devices that provide user input to the computing device 600. The printer 620 is an external device that prints data to paper. Different implementations of the computing device 600 interface with different types of printers. Example types of printers include, but are not limited to laser printers, ink jet printers, photo printers, copy machines, fax machines, receipt printers, dot matrix printers, or other types of devices that print data to paper.

The communications medium 622 facilitates communication among the hardware components of the computing device 600. In different embodiments, the communications medium 622 facilitates communication among different components of the computing device 600. For instance, in the example of FIG. 6, the communications medium 622 facilitates communication among the memory 602, the processing system 604, the secondary storage device 606, the network interface card 608, the video interface 610, and the external component interface 614. In different implementations of the computing device 600, the communications medium 622 is implemented in different ways. For instance, in different implementations of the computing device 600, the communications medium 622 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 602 stores various types of data and/or software instructions. For instance, in the example of FIG. 6, the memory 602 stores a Basic Input/Output System (BIOS) 624, an operating system 626, application software 628, and program data 630. The BIOS 624 includes a set of software instructions that, when executed by the processing system 604, cause the computing device 600 to boot up. The operating system 626 includes a set of software instructions that, when executed by the processing system 604, cause the computing device 600 to provide an operating system that coordinates the activities and sharing of resources of the computing device 600. Example types of operating systems include, but are not limited to, Microsoft Windows®, Linux, Unix, Apple OS X, Apple OS X iPhone, Palm webOS, Palm OS, Google Chrome OS, Google Android OS, and so on. The application software 628 includes a set of software instructions that, when executed by the processing system 604, cause the computing device 600 to provide applications to a user of the computing device 600. The program data 630 is data generated and/or used by the application software 628.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can the steps of the operations shown in the figures in different orders.

We claim:

1. A method comprising:
receiving, by a communication device associated with a user, remote location data, the remote location data conveying information about a current location of an associated communication device;
using, by the communication device, the remote location data to determine whether the associated communication device is nearby, wherein the associated communication device is associated with the user, wherein the associated communication device is nearby when the user is able to concurrently perceive notification actions performed by the communication device and the associated communication device;
performing, by the communication device, a first action when the associated communication device is nearby; and
performing, by the communication device, a second action when there are no communication devices associated with the user nearby, the second action being different than the first action.

2. The method of claim 1,
wherein the method further comprises: receiving, by the communication device, a session invitation, the session invitation being an invitation for the user to participate in a communication session;
wherein the communication device performs the first action in response to receiving the session invitation when the associated communication device is nearby; and
wherein the communication device performs the second action in response to receiving the session invitation when there are no communication devices associated with the user nearby.

3. The method of claim 1, further comprising:
generating, by the communication device, local location data, wherein the local location data conveys information about a current location of the communication device; and
sending, by the communication device, the local location data to a computing device.

4. The method of claim 3, wherein generating the local location data comprises:
detecting, by the communication device, a sound emitted by the associated communication device; and
generating, by the communication device, the local location data such that the local location data indicates that the communication device is currently at a location where the communication device is able to detect the sound emitted by the associated communication device.

5. The method of claim 3, wherein generating the local location data comprises:
detecting, by the communication device, a radio frequency signal emitted by the associated communication device; and
generating, by the communication device, the local location data such that the local location data indicates that the communication device is currently at a location where the communication device is able to detect the radio frequency signal emitted by the associated communication device.

6. The method of claim 3, wherein generating the local location data comprises:
identifying, by the communication device, a network access point through which the communication device is connected to a network; and
generating, by the communication device, the local location data such that the local location data indicates that the communication device is currently at a location associated with the network access point.

7. The method of claim 1,
wherein the method further comprises:
receiving, by the communication device, remote status data, the remote status data comprising at least one of: user status data and device status data, wherein the user status data conveys information about an availability of the user to use the associated communication device to participate in communication sessions, wherein the device status data conveys information about capabilities and state of the associated communication device; and
using, by the communication device, the remote status data to identify one or more appropriate actions;
wherein the first action is one of the appropriate actions.

8. The method of claim 7, wherein using the remote status data to identify the one or more appropriate actions comprises determining that the first action is an appropriate action when the remote status data indicates the user has provided input to the communication device more recently than to the associated communication device.

9. The method of claim 7, wherein using the remote status data to identify the one or more appropriate actions comprises determining that the first action is an appropriate action when an attribute of the remote status data indicates that the associated communication device does not have an ability to present a content stream of a communication session and the communication device has the ability to present the content stream of the communication session.

10. The method of claim 1, wherein the communication device determines whether the associated communication device is nearby while the user is using the communication device to participate in a communication session and the communication device performs the first action while the user is using the communication device to participate in the communication session.

11. A communication device comprising:
a processing system; and
a data storage system that stores software instructions that, when executed by the processing system, cause the communication device to:
send local location data to another computing device, wherein the local location data conveys information about a current location of the communication device;
receive remote location data, the remote location data conveying information about a current location of an associated communication device;
use the remote location data to determine whether the associated communication device is nearby, wherein the communication device is associated with a user and the associated communication device is associated with the user, wherein the associated communication device is nearby when the user is able to concurrently perceive notification actions performed by the communication device and the associated communication device; and
in response to receiving a session invitation from the server system:
perform a first notification action when the associated communication device is nearby; and
perform a second notification action when there are no communication devices associated with the user nearby,
wherein the session invitation is an invitation for the user to participate in a communication session.

12. The communication device of claim 11, wherein the first notification action comprises displaying a user interface element that indicates that the associated communication device is able to provide a particular feature at a higher level than the communication device.

13. The communication device of claim 11, wherein the software instructions, when executed by the processing system, further cause the communication device to generate the local location data.

14. The communication device of claim 13,
wherein the communication device further comprises a microphone; and
wherein the software instructions, when executed by the processing system, further cause the communication device to:
use the microphone to detect a sound emitted by the associated communication device; and
generate the local location data such that the local location data indicates that the communication device is currently at a location where the communication device is able to detect the sound emitted by the associated communication device.

15. The communication device of claim 14,
wherein the communication device further comprises a network interface; and
wherein the software instructions, when executed by the processing system, further cause the communication device to:
use the network interface to detect a radio frequency signal emitted by the associated communication device; and
generate the local location data such that the local location data indicates that the communication device is currently at a location where the communication device is able to detect the radio frequency signal emitted by the associated communication device.

16. The communication device of claim 15,
wherein the software instructions, when executed by the processing system, further cause the communication device to use remote status data to identify one or more appropriate notification actions, the remote status data comprising at least one of: user status data and device status data, wherein the user status data conveys information about an availability of the user to use the associated communication device to participate in communication sessions, wherein the device status data conveys information about capabilities and state of the associated communication device; and
wherein the first notification action is one of the appropriate notification actions.

17. The communication device of claim 16, wherein the software instructions, when executed by the processing system, cause the communication device to identify the first notification action as an appropriate notification action when the remote status data indicates that the user has provided input to the communication device more recently than to the associated communication device.

18. The communication device of claim 16, wherein the software instructions, when executed by the processing system, cause the communication device to identify the first notification action as an appropriate notification action when the associated communication device does not have an ability to present a content stream of the communication session and the communication device has the ability to present the content stream of the communication session.

19. The communication device of claim 16,
wherein the communication device comprises a display screen; and
wherein the software instructions, when executed by the processing system, cause the communication device to determine that the first notification action is an appropriate notification action when a display screen of the associated communication device is locked and the display screen of the communication device is not locked.

20. A computer-readable data storage medium comprising software instructions that, when executed by a processing system of a communication device associated with a user, cause the communication device to:
use a speaker of the communication device to emit a sound;
generate local location data, wherein the local location data conveys information about a current location of the communication device;
send the local location data to a server system; and
in response to receiving a session invitation from the server system:
use remote location data received from the server system to determine whether there is an associated communication device nearby, wherein the associated communication device is associated with the user, wherein the remote location data conveys information about a current location of the associated communication device, wherein the associated communication device is nearby when the user is able to concurrently perceive notification actions performed by the communication device and the associated communication device, wherein the communication device determines that the associated communication device is nearby when the remote location data indicates that the associated communication device is currently at a location where the associated communication device is able to detect the sound emitted by the communication device;
when the associated communication device is nearby:
use remote status data generated by the associated communication device to identify one or more appropriate notification actions, the remote status data comprising at least one of: user status data and device status data, wherein the user status data conveys information about an availability of the user to use the associated communication device to participate in communication sessions, wherein the device status data conveys information about capabilities and state of the associated communication device; and
perform the one or more appropriate notification actions; and
when no communication device associated with the user is nearby, perform a default notification action,
wherein the session invitation is an invitation for the user to participate in a communication session.
